(19) United States
(12) Patent Application Publication
(10) Pub. No.: US 2024/0407599 A1
(43) Pub. Date: Dec. 12, 2024

(54) COOKING DEVICES

(71) Applicant: SharkNinja Operating LLC, Needham, MA (US)

(72) Inventors: Sean Cameron Dorsey, Westborough, MA (US); David J. Hensel, Somerville, MA (US); Peter Joseph Loftus, Somerville, MA (US); Guillem Altimiras Pujadas, Somerville, MA (US)

(21) Appl. No.: 18/330,764

(22) Filed: Jun. 7, 2023

(51) Int. Cl. A47J 37/06

(52) U.S. Cl. CPC A47J 37/0641

(57) ABSTRACT

A cooking device is provided. In an embodiment, the cooking device includes a housing including a first internal volume defining a cooking cavity therein, an opening for accessing the first internal volume, and a second internal volume positioned within the housing adjacent the first internal housing. An internal wall is positioned within the housing and configured to separate the first internal volume from the second internal volume. The internal wall includes at least one opening therein. At least one heating element is positioned within the first internal volume, and an air movement assembly is positioned within the second internal volume. The air movement assembly includes at least one guide vane positioned within the second internal volume. the at least one guide vane is configured to direct an airflow through the at least one opening of the internal wall from the second internal volume into the first internal volume.

### FIELD

Cooking devices that provide convection cooking operations in a compact envelope are provided.

### BACKGROUND

Generally, air fryers can take up a significant amount of space on a countertop due to the need of having an air movement device arranged vertically above the cooking compartment. This can lead to air fryers having a larger height than that of toaster ovens in order to accommodate the air movement device therein. Additionally, when the air fryers are not in use, users generally store the devices on the same countertop surface as the devices sit on when in use. The large envelope that the devices occupy can significantly limit users' use of a countertop.

### SUMMARY

A cooking device is provided. In an embodiment, the cooking device includes a housing including a first internal volume defining a cooking cavity therein, an opening for accessing the first internal volume, and a second internal volume positioned within the housing adjacent the first internal housing. An internal wall is positioned within the housing and configured to separate the first internal volume from the second internal volume. The internal wall includes at least one opening therein. At least one heating element is positioned within the first internal volume, and an air movement assembly is positioned within the second internal volume. The air movement assembly includes at least one guide vane positioned within the second internal volume. the at least one guide vane is configured to direct an airflow through the at least one opening of the internal wall from the second internal volume into the first internal volume.

The air movement assembly can have a variety of configurations. For example, in some embodiments, the air movement assembly can be positioned at an angle between 25 degrees to 35 degrees relative to a vertical axis of the housing. In other embodiments, the air movement assembly can include a motor having a driveshaft, a fan positioned on the driveshaft, and a shroud partially encompassing the fan, and including an interior surface configured to direct the airflow from the fan. In certain embodiments, the at least one guide vane can include a first guide vane positioned on a first side of the shroud, and a second guide vane positioned on a second side of the shroud, wherein the fan can be positioned therebetween. In some embodiments, the first guide vane can direct the airflow from the fan horizontally through the first internal volume. In some embodiments, the air movement assembly can be positioned in an upper rear corner of the housing.

The housing can have a variety of configurations. For example, in some embodiments, the housing can be rotatable between a first horizontal position and a second vertical position. In other embodiments, the housing can further include a pair of rear feet configured to remain in contact with a counter surface in both the first horizontal position and the second vertical position

The at least one heating element can have a variety of configurations. For example, in some embodiments, the at least one heating element can include a top heating element and a bottom heating element. In other embodiments, the top heating element and the bottom heating element can be configured to operate separately.

In one embodiment, a cooking device is provided. The cooking device includes a housing including a first internal volume defining a cooking cavity therein positioned at least partially within a front portion of the housing, and a second internal volume positioned within a rear portion of the housing. An internal wall is positioned between the first internal volume and the second internal volume. The internal wall includes at least one output opening and at least one input opening therein. At least one heating element is positioned within the first internal volume, and an air movement assembly is positioned within the second internal volume the air movement device, including a fan and at least one guide vane. The at least one guide vane is positioned adjacent to the fan within the second internal volume, and configured to direct an airflow through the at least one output opening of the internal wall and horizontally through the first internal volume.

The air movement assembly can have a variety of configurations. For example, in some embodiments, the air movement assembly can be positioned at an angle between 25 degrees to 35 degrees relative to a vertical axis of the housing. In other embodiments, the air movement assembly can include a motor having a driveshaft, a fan positioned on the driveshaft, and a shroud partially encompassing the fan, and including an interior surface configured to direct the airflow from the fan. In certain embodiments, the at least one guide vane can include a first guide vane positioned on a first side of the shroud, and a second guide vane positioned on a second side of the shroud, wherein the fan can be positioned therebetween. In some embodiments, the first guide vane and the second guide vane can direct the airflow from the fan horizontally through the first internal volume. In some embodiments, the air movement assembly can be positioned in an upper rear corner of the housing.

The housing can have a variety of configurations. For example, in some embodiments, the housing can be rotatable between a first horizontal position and a second vertical position. In other embodiments, the housing can further include a pair of rear feet configured to remain in contact with a counter surface in both the first horizontal position and the second vertical position

The at least one heating element can have a variety of configurations. For example, in some embodiments, the at least one heating element can include a top heating element and a bottom heating element. In other embodiments, the top heating element and the bottom heating element can be configured to operate separately.

### BRIEF DESCRIPTION OF THE DRAWINGS

These and other features will be more readily understood from the following detailed description taken in conjunction with the accompanying drawings, in which:

FIG. 1 is a front perspective view of one embodiment of a cooking device;

FIG. 2 is a side view of the cooking device of FIG. 1;

FIG. 3 is a front perspective view of the cooking device of FIG. 1, showing a door in an open configuration;

FIG. 4 is a side perspective view of the cooking device of FIG. 1, showing the cooking device in a vertical position;

FIG. 5 is a side cross-sectional view of the cooking device of FIG. 1 taken along line 5-5 in FIG. 1;

FIG. 6 is a front cross-sectional view of the cooking device of FIG. 1 taken along line 6-6 in FIG. 1;

FIG. 6A is a bottom cross-sectional view of the cooking device of FIG. 1 taken along line 6A-6A in FIG. 1;

FIG. 7 is an isolated perspective view of an inner liner of the cooking device of FIG. 1;

FIG. 8 is a rear isolated perspective view of the inner liner of FIG. 7, with an air movement assembly attached thereto;

FIG. 9 is a top isolated view of the air movement assembly of FIG. 8;

FIG. 10 is a front view of the air movement assembly of FIG. 9;

FIG. 11 is a front perspective view of the air movement assembly of FIG. 10;

FIG. 12 is an isolated perspective view of an embodiment of an air movement assembly;

FIG. 13 is a front perspective view of a portion of the air movement assembly of FIG. 12; and

FIG. 14 is a front view of the air movement assembly of FIG. 13.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

As stated above, air fryers can take up significant space on a countertop due to the required air movement device in order to create forced convection heating. In order to reduce the envelope of an air fryer, while still providing forced convection, the air movement device can be moved to a rear of a housing in order to create horizontal flow. By moving the air movement device to the rear of the housing, and horizontally aligning it with the cooking chamber, air frying can still be achieved while reducing the overall envelope of the present invention. In addition to positioning an air movement device at the rear of the housing, air guides are arranged adjacent to the fan to reduce the angular acceleration of heated air from the fan to encourage the heated air to travel linearly down the length of a cooking chamber. This ensures that food is cooked evenly within the cooking chamber, even though the air movement device is arranged on a single side of a food load within the cooking chamber.

Further, a cooking device is provided that is able to rotate into a vertical position when not in use to decrease the envelope required to store the device.

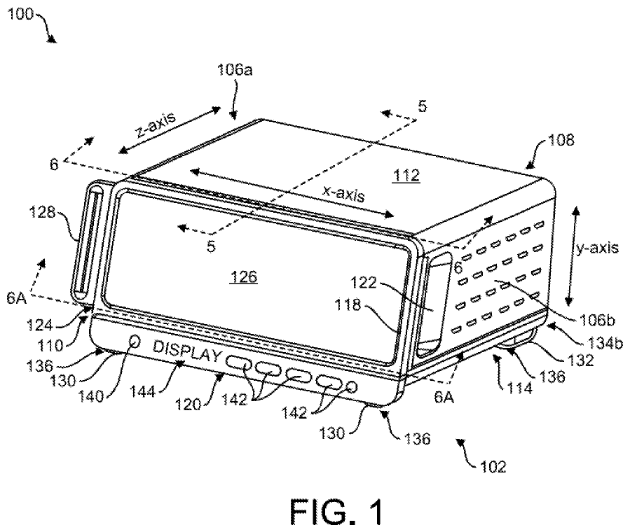

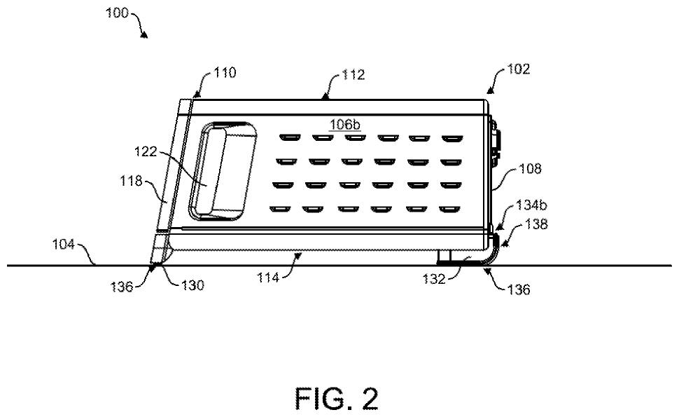

FIGS. 1-2 illustrate a cooking device 100 having a housing 102. The cooking device 100 is designed to rest upon a counter surface 104, as illustrated in FIG. 2. The housing 102 includes two side walls 106a and 106b, a rear wall 108, a front wall 110, a top surface 112, and a bottom surface 114. The two side walls 106a and 106b connect perpendicularly to the rear wall 108 and to the front wall 110. The top surface 112 and bottom surface 114 each connect to the sidewalls 106a and 106b, to the rear wall 108, and to the front wall 110 to form an internal cooking volume 146, described below in more detail. The side walls 106a and 106b, the rear wall 108, the front wall 110, the top surface 112, and the bottom surface 114 can be formed from a single piece of metal, or alternatively, from separate pieces of metal and fused together to form the housing 102. The housing 102 further includes a door 118 and a user interface 120, each described below in more detail. The sidewalls 106a and 106b, the rear wall 108, the front wall 110, the top surface 112, and the bottom surface 114 can be formed from riveted metal and configured to insulate the internal cooking volume 146.

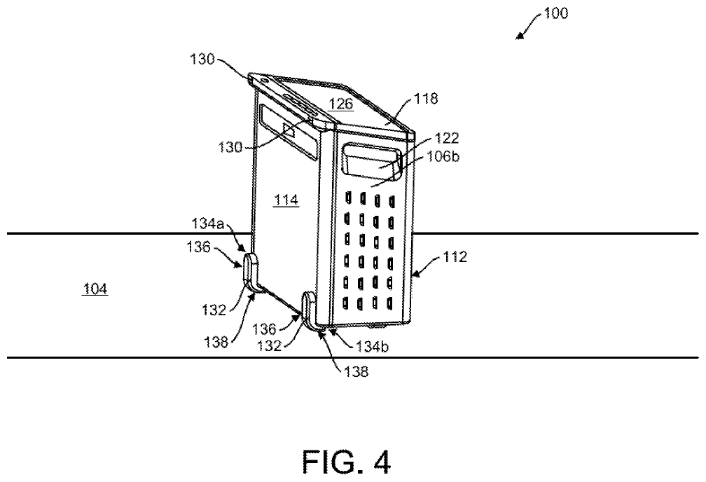

The sidewalls 106a and 106b can each further include a notch 122. The notch 122 can be oblong in shape, and can aid a user in handling the cooking device 100 for rotation from a first position, illustrated in FIGS. 1-3, to a second position, illustrated in FIG. 4, as described in greater detail below.

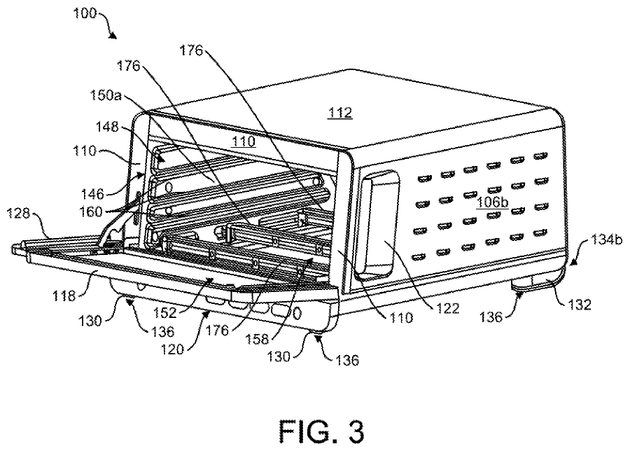

As shown in FIG. 1, the door 118 is pivotally coupled to the front wall 110 along a bottom edge 124 in order to access the internal cooking volume 146. Alternatively, the door 118 can be pivotally coupled to the front wall 110 along a side edge or a top edge. The door 118 can include a rectangular pane of glass 126 extending across the door 118. The door 118 can further include a handle 128 extending from the side of the door 118. The door 118 can pivot between a closed position, illustrated in FIGS. 1-2 and 4, and an open position, illustrated in FIG. 3.

As shown in FIG. 1, a user interface 120 can be positioned on the front wall 110 adjacent the bottom edge 124. The user interface 120 extends below the door 118. The user interface 120 includes a power button 140 and input buttons 142 corresponding to different cooking modes such as toast, air fry, and broil. The different cooking modes are described below in more detail. The user interface 120 further includes a display 144 to indicate to the user which cooking mode is selected and/or to display the current temperature of the cooking device 100.

Coupled to a bottom surface of the housing 102 is a front pair of rectangular, static feet 130. A rear pair of static feet 132 are coupled the bottom surface 114 of housing 102 in the rear. Each rear foot 132 extends from the bottom surface 114 to the rear wall 108 such that each rear foot 132 forms a continuous U-shape around bottom-rear corners 134a and 134b of housing 102. When the cooking device 100 is in the first position, illustrated in FIG. 1, bottom surfaces 136 of both the front feet 130 and the rear feet 132 rest against the counter surface 104. Alternatively, when the cooking device 100 is in the second position, illustrated in FIG. 4, no part of the front feet 130 remain in contact with the counter 101. However, a rear surface 138 of each rear foot 132 rests against the counter 101 when the cooking device 100 is in the second position.

When the cooking device 100 is in the first position (as shown in FIG. 1), the housing 102 rests horizontally on the counter 101. In the first position, the bottom surfaces 136 of the front feet 130 and the bottom surfaces 136 of the rear feet 132 rest against the counter 101, as described above. When in the first position, the cooking device 100 is operable to cook food as an air fryer. When the user wishes to store the cooking device 100, the user can grasp the notches 122 of sidewalls 106a and 106b to rotate the cooking device 100 vertically so that the rear surfaces 138 of the rear feet 132 rest on the counter 101. The cooking device 100 can be stored in this vertical orientation of the second position. The cooking device 100 can be non-operational when stored in the second position.

FIGS. 3 and 5-8 illustrate the internal cooking volume 146 of cooking device 100. The internal cooking volume 146 can define a hollow cooking cavity 148. In an aspect, the internal cooking volume can support a food load that is 12″×12″ within a cooking envelope in the X-Z plane. However, other dimensions of the cooking envelope can be appreciated within the scope of this disclosure. The internal cooking volume 146 can be formed from internal sidewalls 150a and 150b, an internal front wall 152, an internal rear wall 154, an internal top wall 156, and an internal bottom wall 158. The inner surface of the door 118 can define the internal front wall 152.

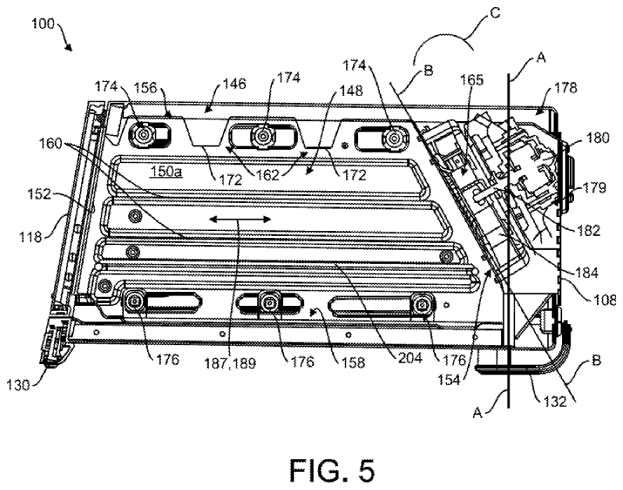

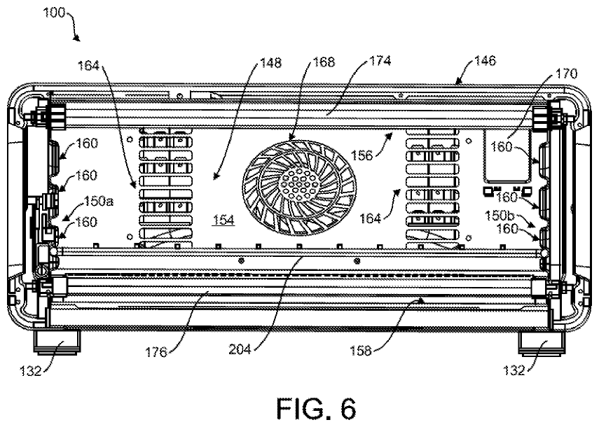

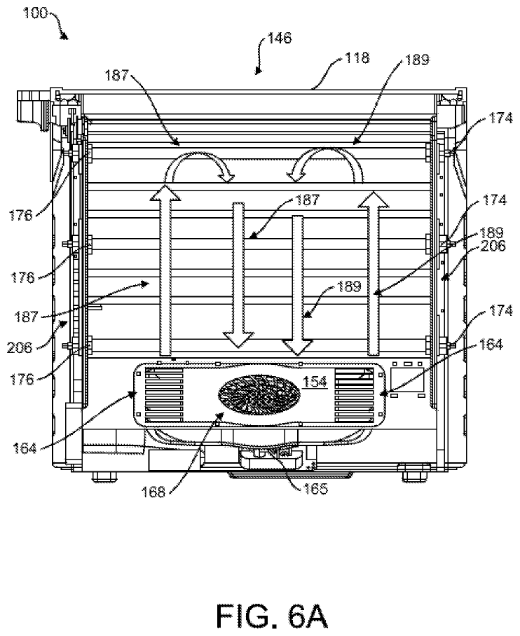

As illustrated in FIGS. 3 and 5-6, the internal sidewalls 150a and 150b include a plurality of ridges 160 on the inside surfaces. Each ridge 160 can extend longitudinally along the z-axis of the cooking device 100. As shown in FIGS. 5-6, a mesh tray 204 can be placed within the internal cooking volume 146, about a third of the way up from the bottom surface 114. The tray 204 can rest between ridges 160. The tray 204 can operate to hold food to be cooked within the cooking device 100.

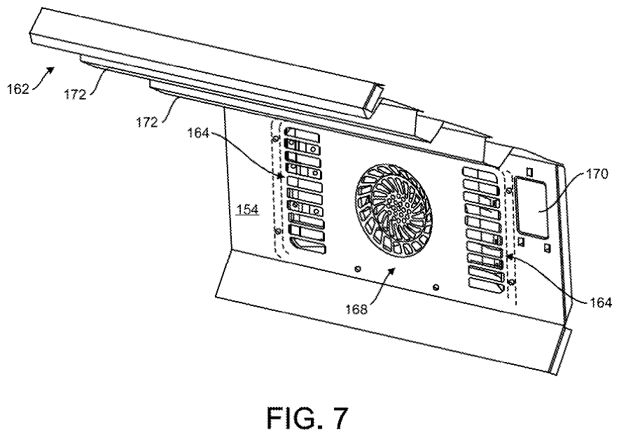

As illustrated in FIGS. 6-7, the internal rear wall 154 includes a plurality of spaced openings 164 to allow airflows 187 and 189 to move from guide vanes 196a and 196b to the internal cooking volume 146. The internal rear wall 154 further includes a circular grouping of angled openings 168 to airflows 187 and 189 to travel from the internal cooking volume 146 to a fan 165.

In an embodiment, as illustrated in FIG. 6, a light 170 can be positioned on the internal rear wall 154 to illuminate the cooking cavity 148. The light 170 can be positioned outside of the cooking cavity 148.

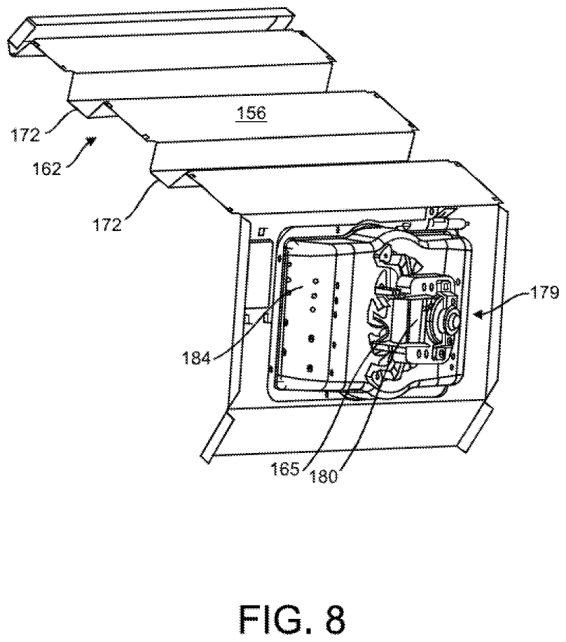

The internal top wall 156 includes deflectors 162 arranged between top heating elements 174, as illustrated in FIGS. 7 and 8. The top heating elements 174 are described below in more detail. The deflectors 162 extend longitudinally along the X-axis of the internal top wall 156. The deflectors 162 include alternating protrusions 172 which are positioned between top heating elements 174. The protrusions 172 project downward from the internal top wall 156 toward the hollow cooking cavity 148. The deflectors 162 can function to direct heat downward into the hollow cooking cavity 148.

Still referring to FIGS. 5-6, in order to produce heat within the internal cooking volume 146, the internal cooking volume 146 includes three top heating elements 174 and three bottom heating elements 176. The heating elements 174 and 176 are formed as cylindrical rods that extend longitudinally along the x-axis of the internal cooking volume 146, from internal sidewall 150a to internal sidewall 150b. Each of the top heating elements 174 are evenly spaced apart from each other and each of the bottom heating elements 176 are evenly spaced apart from each other. Heating elements 174 and 176 can be made of quartz, calrod, carbon fiber, or any other suitable material. Heating elements 174 and 176 are connected to the user interface 120. Heating elements 174 and 176 cycle on and off to maintain the cooking cavity 148 at a desirable temperature. For example, when a user selects “Broil” mode on the user interface 120, the top heating elements 174 may be on while the bottom heating elements 176 will be off.

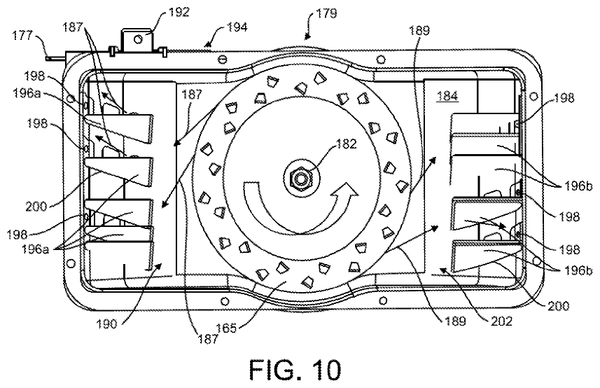

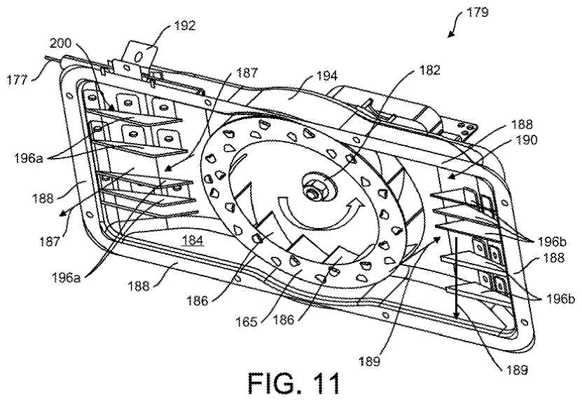

FIGS. 10-11 illustrate a thermometer 177. The thermometer 177 is operably connected to the heating elements 174 and 176, as well as to the user interface 120. The thermometer 177 can detect a temperature of the internal cooking volume 146 and display the temperature on the user interface 120. The thermometer 177 can be configured to disconnect the power to the heating elements 174, 176 when a threshold temperature is reached within the cooking cavity 148.

The cooking device 100 is designed to occupy a reduced envelope. Accordingly, the arrangement of components of the cooking device 100 can result in most of the cooking device's weight being in the rear.

As illustrated in FIG. 5, in addition to the cooking cavity 148, the housing 102 includes an internal volume 178 positioned adjacent to the cooking cavity 148. The internal volume 178 is positioned in a top rear corner of housing 102, and is separated from the cooking cavity 148 by the internal rear wall 154. Positioned within internal volume 178 is an air movement assembly 179. In order to reduce the overall envelope size of the cooking device 100, the air movement assembly 179 angled within the housing 102. In an aspect, the air movement assembly 179 is positioned at an angle C, such that the fan 165 is aligned with the axis B (shown in FIG. 5). The angle C can be within the range of 0-90 degrees between the vertical axis A of the housing 102, and the axis B of the fan 165. This angled arrangement reduces the horizontal space required in the housing 102 to fit the air movement device 179 to enable forced convection cooking processes. In an aspect the angle C can be within the range of 25-35 degrees, or specifically 30 degrees. Reducing the angle C aids in reducing the amount of redirection of the airflow from the fan into the cooking cavity. However, reducing the angle C also reduces the amount of available space within the internal volume 178. Therefore, having the fan 165 at 30 degrees allows for sufficient space within the internal volume 178 for the air movement assembly 179, which also minimizing the directional change required for the airflow.

As further illustrated in FIG. 5, the air movement assembly 179 includes a motor 180. The motor 180 is coupled to the housing 102 and functions to drive a fan 165 on and off. The motor 180 is further operably connected to the user interface 120. For example, the motor 180 can be on in “Air fry” mode but off for “Toast,” “Broil,” and “Bake.” Also included in the air movement assembly 179 is the fan 165. Extending through the motor 180, a driveshaft 182 physically couples the fan 165 to the motor 180. The fan 165 is positioned adjacent to the motor 180. As illustrated in FIGS. 10-11, the fan 165 is circular and a centrifugal fan. The fan 165 includes curved blades 186, which angle inward along the inner circumference of the fan 165. The fan 165 can rotate both clockwise and counterclockwise.

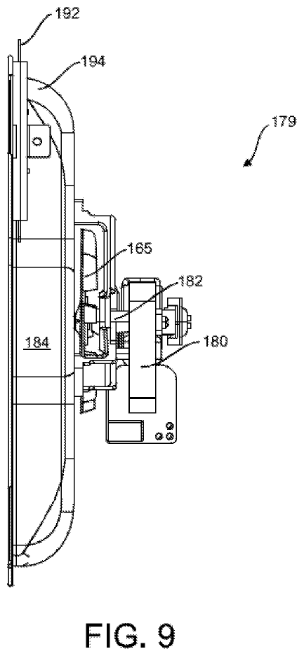

The air movement assembly 179 further includes a shroud 184 illustrated in FIGS. 8-11. The shroud 184 surrounds the fan 165 in order to aid in directing air into the cooking cavity 148. The driveshaft 182 passes through the shroud 184 to help secure the fan 165 to the motor 180. Distal edges 188 of shroud 184 can be connected to the internal rear wall 154 via screws (not pictured). The shroud 184 can be shaped like a bowl, with an interior curved surface 190 expanding out as the interior curved surface 190 extends toward the internal cooking volume 146. A tab 192 and the thermometer 177 extend from on a top edge 194 of the shroud 184.

As illustrated in FIGS. 10-11, a plurality of guide vanes 196a and 196b are positioned along the interior curved surface 190 of the shroud 184 and on either side of the fan 165. The guide vanes 196a and 196b can be connected to the shroud 184 via stubs 198. Curved rear edges 200 of guide vanes 196a and 196b can connect to the interior curved surface 190 of the shroud 184, such that the curved rear edges 200 conform to a curve 202 of the interior curved surface 190. The guide vanes 196a and 196b can be made of metal and are positioned 30 degrees off-axis from an angle of rotation of the fan 165. The guide vanes 196a and 196b function to direct air generated by the fan 165 through the spaced openings 164 of the internal rear wall 154 and into the cooking cavity 148. The guide vanes 196a on one side of the fan 165 may be shaped differently from the guide vanes 196b on the opposite side of the fan 165 in order to accommodate different angular directions of air being moved by the fan 165.

As illustrated by the arrows in FIGS. 10-11, when the fan 165 rotates in a counterclockwise direction, a first airflow 187 glides in a downward direction away from the fan 165 and toward guide vanes 196a . Upon contact with guide vanes 196a , airflow 187 is directed upward and away from guide vanes 196a . Conversely, a second airflow 189 glides in an upward direction away from the fan 165 and toward guide vanes 196b . When airflow 189 makes contact with guide vanes 196b , airflow 189 is directed downward and away from guide vanes 196b . While the air is directed upward and downward by the guide vanes 196a , 196b , due to the angular position of the fan 165 relative to the cooking cavity 148, the air 187, 189 is directed horizontally through the openings 164 within the internal rear wall 154, and across a food load within the internal cooking volume 146.

FIGS. 5 and 6A illustrate the airflows 187 and 189 traveling through the internal cooking volume 146. As discussed above, when the motor 180 powers the fan 165 on, air is forced outward by the fan 165 through the guide vanes 196a and 196b . The guide vanes 196a and 196b direct the air through the spaced openings 164 of the internal rear wall 154 into the internal cooking volume 146. Once inside the internal cooking volume 146, the air travels along the top heating elements 174 and along the bottom heating elements 176. The heated air flows over the food load (not pictured) positioned within the internal cooking volume 146. When the air reaches the door 118, the air turns 180 degrees away from the edges 206 of the internal cooking volume 146 and travels back over the food load (not pictured) toward the internal rear wall 154. Once the air reaches the internal rear wall 154, the air flows through the circular grouping of angled openings 168 back to the fan 165.

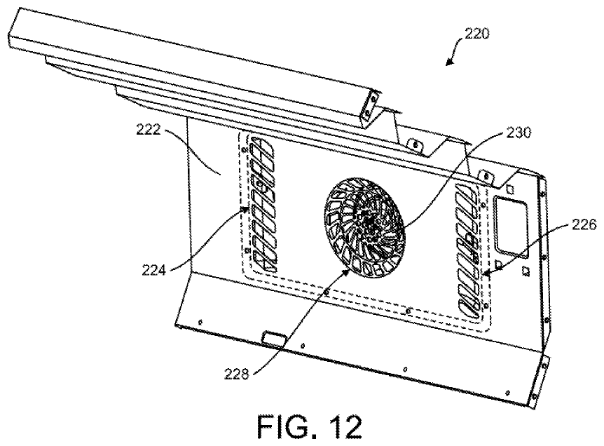

FIGS. 12-14 illustrate an embodiment of an air movement assembly 220. The an air movement assembly 220 is similar to the an air movement assembly 179, and as such, like components are not discussed in detail. The an air movement assembly 220 is attached to an inner rear wall 222, which includes output openings 224 and 226, and an inlet opening 228. The outlet openings 224 and 226 are angled to help direct the airflow being generated by the fan 203. The output openings 224 can be 22 mm wide, and the output openings 226 can be 20 mm wide. This difference in width can help balance the airflow throughout the cooking cavity, and promote a better average of air speeds across the cavity, with a smaller delta between the maximum and minimum speeds, and a higher average speed overall.

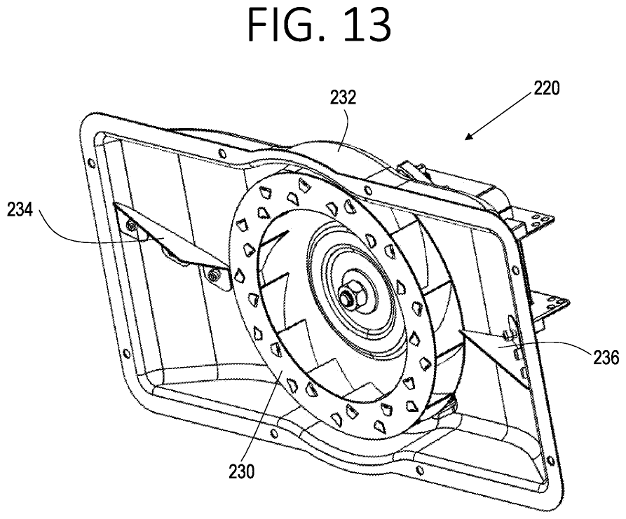

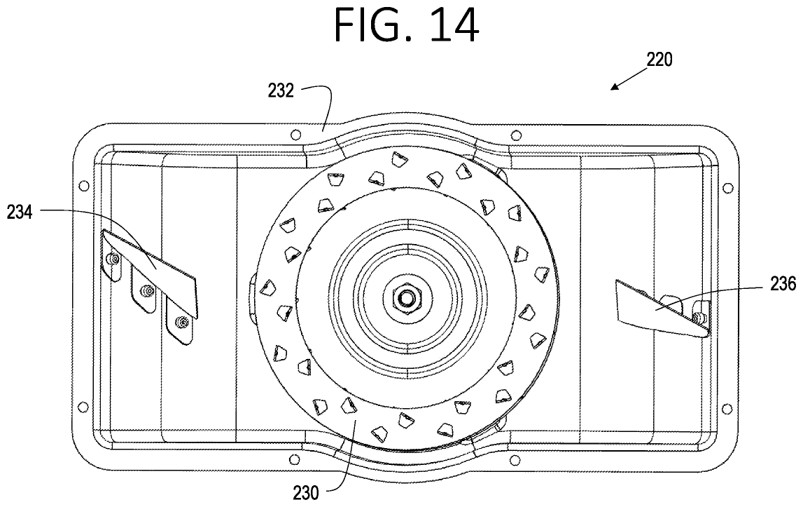

As shown in FIG. 13, the air movement assembly 220 includes a shroud 232 with guide vanes 234 and 236 arranged on either side of the fan 230. Compared to the an air movement assembly 179, the guide vanes 234, 236 are positioned at a greater angle (as shown in FIG. 14) than the guide vanes of the an air movement assembly 179. This is to hide the vanes, and prevent restriction of the air flow path. Additionally, there is only a singular guide van on each side of the fan 230.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

Certain exemplary implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A cooking device, comprising:
a housing including a first internal volume defining a cooking cavity therein, an opening for accessing the first internal volume, and a second internal volume positioned within the housing adjacent the first internal housing;
an internal wall positioned within the housing and configured to separate the first internal volume from the second internal volume, wherein the internal wall includes at least one opening therein;
at least one heating element positioned within the first internal volume; and
an air movement assembly positioned within the second internal volume,
wherein the air movement assembly includes at least one guide vane positioned within the second internal volume, the at least one guide vane configured to direct an airflow through the at least one opening of the internal wall from the second internal volume into the first internal volume.

2. The cooking device of claim 1, wherein the air movement assembly is positioned at an angle between 25 degrees to 35 degrees relative to a vertical axis of the housing.

3. The cooking device of claim 1, wherein the air movement assembly includes:
a motor having a driveshaft;
a fan positioned on the driveshaft; and
a shroud partially encompassing the fan, and including an interior surface configured to direct the airflow from the fan.

4. The cooking device of claim 3, wherein the at least one guide vane includes a first guide vane positioned on a first side of the shroud, and a second guide vane positioned on a second side of the shroud, wherein the fan is positioned therebetween.

5. The cooking device of claim 4, wherein the first guide vane directs the airflow from the fan horizontally through the first internal volume.

6. The cooking device of claim 1, wherein the air movement assembly is positioned in an upper rear corner of the housing.

7. The cooking device of claim 1, wherein the housing is rotatable between a first horizontal position and a second vertical position.

8. The cooking volume of claim 7, wherein the housing further comprises a pair of rear feet configured to remain in contact with a counter surface in both the first horizontal position and the second vertical position.

9. The cooking device of claim 1, wherein the at least one heating element includes a top heating element and a bottom heating element.

10. The cooking device of claim 9, wherein the top heating element and the bottom heating element are configured to operate separately.

11. A cooking device, comprising:
a housing including a first internal volume defining a cooking cavity therein positioned at least partially within a front portion of the housing, and a second internal volume positioned within a rear portion of the housing;
an internal wall positioned between the first internal volume and the second internal volume, wherein the internal wall includes at least one output opening and at least one input opening therein;
at least one heating element positioned within the first internal volume; and
an air movement assembly positioned within the second internal volume the air movement device, including a fan and at least one guide vane,
wherein the at least one guide vane is positioned adjacent to the fan within the second internal volume, and configured to direct an airflow through the at least one output opening of the internal wall and horizontally through the first internal volume.

12. The cooking device of claim 11, wherein the air movement assembly is positioned at an angle between 25 degrees to 35 degrees relative to a vertical axis of the housing.

13. The cooking device of claim 11, wherein the air movement assembly includes a shroud partially encompassing the fan, and including an interior surface configured to direct the airflow from the fan.

14. The cooking device of claim 13, wherein the at least one guide vane includes a first guide vane positioned on a first side of the shroud, and a second guide vane positioned on a second side of the shroud, wherein the fan is positioned therebetween.

15. The cooking device of claim 14, wherein the first guide vane and the second guide vane direct the airflow from the fan horizontally through the first internal volume.

16. The cooking device of claim 11, wherein the air movement assembly is positioned in an upper corner of the rear portion of the housing.

17. The cooking device of claim 11, wherein the housing is rotatable between a first horizontal position and a second vertical position.

18. The cooking volume of claim 17, wherein the housing further comprises a pair of rear feet configured to remain in contact with a counter surface in both the first horizontal position and the second vertical position.

19. The cooking device of claim 11, wherein the at least one heating element includes a top heating element and a bottom heating element.

20. The cooking device of claim 19, wherein the top heating element and the bottom heating element are configured to operate separately.
